(19) United States
(12) Patent Application Publication
(10) Pub. No.: US 2008/0168521 A1
(43) Pub. Date: Jul. 10, 2008

(54) APPARATUS FOR MANAGING PROCESS OF SET-TOP BOX AND METHOD THEREOF

(76) Inventors: Ming-Tso Hsu, Taipei City (TW); Chih-Jen Wen, Tai-Chung City (TW); Hsu-Sheng Huang, Taipei County (TW)

Correspondence Address: NORTH AMERICA INTELLECTUAL PROPERTY CORPORATION, P.O. BOX 506, MERRIFIELD, VA, 22116, US

(21) Appl. No.: 11/621,076

(22) Filed: Jan. 8, 2007

(51) Int. Cl. H04N 7/173

(52) U.S. Cl. 725/131

(57) ABSTRACT

The present invention discloses a process for managing method manages a first process and a second process executed on a set-top box (STB), wherein the first process is utilized for performing playback of a multimedia content, the second process is utilized for a specific function, the method includes: when switching from the first process to the second process, resuming the second process; and when switching from the second process to the first process, pausing the second process.

### BACKGROUND OF THE INVENTION

1. Field of the Invention

The present invention relates to a process managing apparatus and method thereof, and more particularly, to the process management of a set-top box (STB).

2. Description of the Prior Art

In modern television broadcast systems, a wide variety of interactive digital television (DTV) content is broadcasted to the home from broadcast facilities. The inclusion of commercials may constitute an unwanted distraction when a user is enjoying a broadcasted TV program, so set-top-boxes (STB) of an interactive DTV offers video games as an alternative means of entertainment during commercial breaks. Conventionally, the user is unable to pause and then resume a video game from the same point. Besides, the user also must restart the video game at the beginning of each commercial break. Similarly, if the user pauses the video game in order to handle some affairs, the video game must then be restarted if the user wishes to resume play. In other words, the video game cannot be resumed from the paused position.

Please refer to FIG. 1, which is a timing diagram illustrating a conventional process management. A user is watching a broadcasted TV program P1′, and a commercial C1′ is played at time t₁. If the user wishes to skip the commercial break period, the user can use a controller (e.g. a remote controller) to switch the broadcasted TV program P1′ to a game mode. Then, the desired video game GAME′ stored in the set-top box is started. The user can play the video game GAME′ during the time interval t₁˜t₂. The commercial C1′ ends at time t₂. When time t₂ is reached, the user uses the controller to switch back to the broadcasted TV program P1′. Conventionally, the state condition of the video game GAME′ at time t₂ will be stopped. When another commercial C2′ starts at time t₃, the user uses the controller to switch from the broadcasted TV program P1′ to the game mode at time t₃. Then, the desired video game GAME′ is restarted since there is no mechanism to resume the video game GAME′ that is previously stopped at time t₂. This causes an inconvenience to the user whenever there are commercials interleaved in a TV program.

### SUMMARY OF THE INVENTION

An objective of the present invention is to provide a process managing apparatus applied to the set-top box and a method thereof, to solve the above-mentioned problem.

According to an embodiment of the present invention, a process for managing a first process and a second process executed on a set-top box (STB) is disclosed, wherein the first process is utilized for performing playback of a multimedia content, and the second process is utilized for a specific function. The method comprises: while switching from the first process to the second process, resuming the second process is resumed; and while switching from the second process to the first process, the second process is paused.

According to another embodiment of the present invention, an apparatus for managing a first process and a second process executed on a set-top box (STB) is disclosed, wherein the first process is utilized for performing playback of a multimedia content, and the second process is utilized for a specific function. The apparatus comprises a kernel, which is utilized for resuming the second process when switching from the first process to the second process, and for pausing the second process when switching from the second process to the first process.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a timing diagram illustrating a conventional process management.

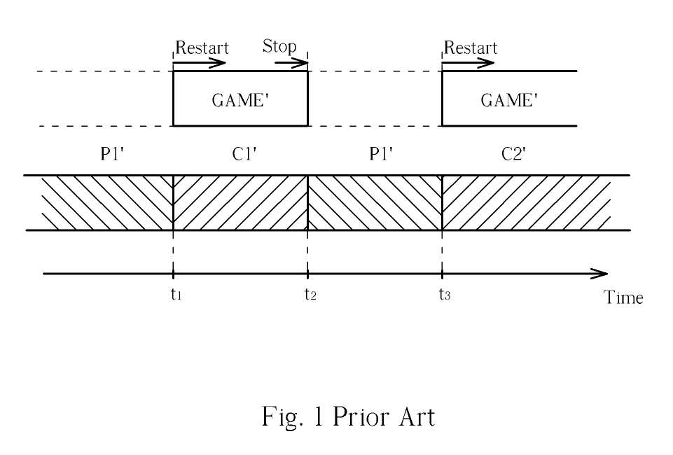

FIG. 2 is a diagram illustrating a television system employing a process management according to the present invention.

FIG. 3 is a diagram illustrating a process managing method according to an embodiment of the present invention.

FIG. 4 is a timing diagram illustrating the process managing method applied to a first process and a second process according to the present invention.

### DETAILED DESCRIPTION

Certain terms are used throughout the description and the following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

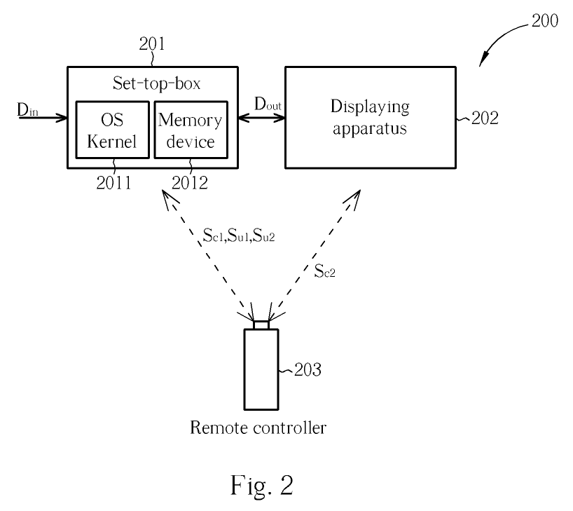

Please refer to FIG. 2, which is a diagram illustrating a television system 200 employing a process management according to the present invention. The television system comprises a set-top box (STB) 201 acting as a process managing apparatus, a display apparatus 202, and a remote controller 203. According to the present invention, the set-top box 201 comprises an operating system kernel (OS Kernel) 2011 and a memory device 2012. The set-top box 201 receives an input data Dᵢₙ and then processes the input data Dᵢₙ to generate an output data Dₒᵤₜ. The output data Dₒᵤₜ is then transferred to the display apparatus 202 for display. Furthermore, a user can either use the remote controller 203 to transmit a first control signal S_{c1} to the set-top box 201 to activate one of the processes that has been stored within the set-top box 201; or use the remote controller 203 to transmit a second control signal S_{c2} to the display apparatus 202 for switching channels in order to decide which program in the output data Dₒᵤₜ is going to be displayed thereon. Please note that the processes stored within the set-top box 201, for example, can be video games; and the displayed program, for example, can be a live TV program. However, this is not meant to be a limitation of the present invention.

Please refer to Fig, which illustrates a process managing method according to an embodiment of the present invention. The method comprises the following steps:

Step 301: Process a first process P1 by the set-top box 201;

Step 302: Switch from the first process P1 to a second process P2;

Step 303: If the second process P2 has been activated, go to step 304; if the second process P2 has not been activated, go to step 305;

Step 304: Resume the second process P2 from the memory device 2012; go to step 306;

Step 305: Activate the second process P2 and process the second process P2; go to step 306;

Step 306: Switch from the second process P2 to the first process P1

Step 307: Pause the second process P2 and save state conditions of the second process P2 at the moment of pausing; and

Step 308: Process the first process P1 by the set-top box 201.

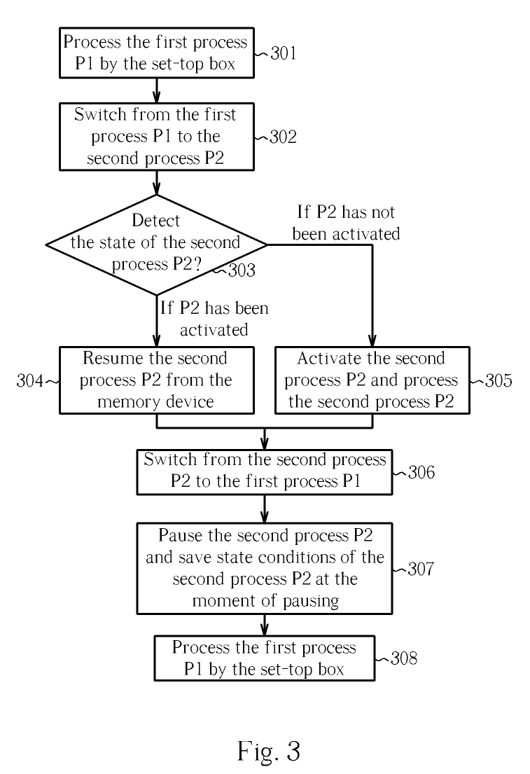

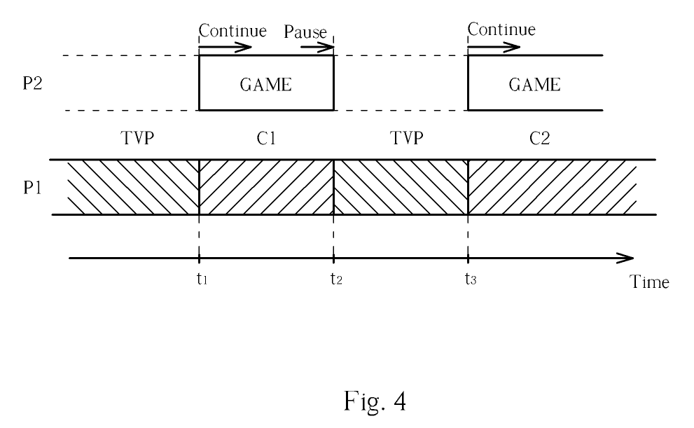

The process managing method is utilized in the television system 200 of FIG. 2 for managing a first process P1 and a second process P2 executed on the set-top box 201, where the first process P1 is utilized for playback of a live multimedia content, and the second process P2 is utilized for a specific function. The first process, for example, can be a live TV program TVP; and the second process, for example, can be a video game GAME. However, this is for illustrative purposes only, and is not meant to be a limitation of the present invention. Please refer to FIG. 4 in conjunction with FIG. 3. FIG. 4 is a timing diagram illustrating the process managing method applied to the first process P1 and the second process P2. The user is enjoying a live TV program TVP (step 301), and there is a commercial C1 at time t₁. If the user wants to skip the commercial C1, one option is to use the remote controller 203 to switch the live TV program TVP to a game mode. Please note that the second process of the present invention is not limited to a game mode; other modes are also possible and belong within the scope of the present invention, such as a playback mode of a DVD movie.

If the user decides to switch the live TV program TVP to the game mode (step 302), the user uses the remote controller 203 to issue a user command Sᵤ₁ to the set-top box 201, then the OS Kernel 2011 switches the live TV program TVP to the game mode at time t₁. If the desired video game GAME has not been activated previously, the OS Kernel 2011 activates the desired video game GAME stored in the set-top box 201 (step 303). Then the user can play the requested video game GAME in the time interval t₁˜t₂. Meanwhile, the commercial C1 ends at time t₂. When the time t₂ is reached, the user uses the remote controller 203 to issue another user command Sᵤ₂ to the set-top box 201, then the OS Kernel 2011 pauses the video game GAME and switches back to the live TV program TVP at time t₂ (step 307). At the same time, the OS Kernel 2011 of the set-top box 201 stores the resource (the state conditions) assigned to the video game GAME paused at time t₂ into the memory device 2012 (step 307). Accordingly, the user can continue enjoying the live TV program TVP (step 308). At time t₃, another commercial C2 comes, the user uses the remote controller 203 to issue a user command Sc1 to the set-top box 201, and the OS Kernel 2011 switches the live TV program TVP to the game mode at time t₃. At the same time, the OS Kernel 2011 of the set-top box 201 loads the stored resource (the state conditions at time t₂) of the video game GAME from the memory device 2012 to resume the video game GAME (step 304). Therefore, at time t₃ the user can continue playing the video game GAME paused at time t₂ (step 305). Furthermore, in step 307, the resource assigned to the video game GAME by the OS Kernel 2011 includes the image of executable, the memory state, the security attributes (set of permissions), the OS descriptors of resource (e.g. file descriptors in UNIX or handles in Windows), the processor state (context), and so on. In addition, the components of the resource are important for the video game GAME. Hence, if the user wants to pause the video game GAME, the resources can be held for reference when the video game GAME is resumed by utilizing the disclosed process management.

On the other hand, in order to make the user aware of the state of the commercial C1, the display mode of the video game GAME can be presented by PIP or Alpha blending in the time interval t₁ and t₂. PIP and Alpha blending are both conventional processes, thus corresponding detailed description are omitted here for the sake of brevity. Furthermore, there is no limitation to the switching time of the present invention; in other words, the user can use the remote controller 203 to switch the live TV program TVP to the game mode and then load the stored resource of the video game GAME at any time; and pause the video game GAME and then save the current resource of the video game GAME at any time.

Moreover, the process managing method according to the present invention neither increases the computational loading of the OS kernel running on the set-top box nor affects the stability of the OS kernel. In short, compared to the conventional process management applied to the set-top box, the process management according to the present invention, which is capable of supporting process pausing and process resuming, offers excellent audio/video entertainment for users.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for managing a first process and a second process executed on a set-top box (STB), the first process utilized for performing playback of a multimedia content, the second process utilized for a specific function, the method comprising:
when switching from the first process to the second process, resuming the second process; and
when switching from the second process to the first process, pausing the second process.

2. The method of claim 1, wherein the switching between the first process and the second process is controlled by a user command.

3. The method of claim 1, wherein the step of pausing the second process comprises:
storing at least a resource currently assigned to the second process.

4. The method of claim 1, wherein the step of resuming the second process comprises:
loading the stored resource to resume the second process.

5. The method of claim 1, wherein the multimedia content is a TV program.

6. The method of claim 1, wherein the multimedia content is a DTV program.

7. The method of claim 1, wherein the specific function is a video game entertainment.

8. An apparatus for managing a first process and a second process executed on a set-top box (STB), the first process utilized for performing playback of a multimedia content, the second process utilized for a specific function, the apparatus comprising:
a kernel, for resuming the second process when switching from the first process to the second process, and for pausing the second process when switching from the second process to the first process.

9. The apparatus of claim 8, wherein the kernel comprises a user command for controlling the switching between the first process and the second process.

10. The apparatus of claim 8, further comprising:
a memory device, for storing at least a resource assigned to the second process when the kernel pauses the second process, and the kernel loads the stored resource from the memory device to resume the second process when the kernel resumes the second process.

11. The apparatus of claim 8, wherein the multimedia content is a TV program.

12. The apparatus of claim 8, wherein the multimedia content is a DTV program.

13. The apparatus of claim 8, wherein the specific function is a video game entertainment.
